(19) United States
(12) Patent Application Publication
(10) Pub. No.: US 2026/0046968 A1
(43) Pub. Date: Feb. 12, 2026

(54) NETWORK REPEATER DEVICES AND CONTROL METHODS

(71) Applicant: Telefonaktiebolaget LM Ericsson (publ), Stockholm (SE)

(72) Inventors: Mattias BERGSTRÖM, Sollentuna (SE); Antonino ORSINO, Kirkkonummi (FI); Lei BAO, Göteborg (SE); Magnus ÅSTRÖM, Lund (SE)

(21) Appl. No.: 19/101,514

(22) PCT Filed: Jul. 16, 2023
(86) PCT No.: PCT/SE2023/050741

§ 371 Date: Feb. 5, 2025

Related U.S. Application Data
(60) Provisional application No. 63/370,834, filed on Aug. 9, 2022.

(51) Int. Cl. H04W 76/19; H04L 43/0811; H04W 76/20

(52) U.S. Cl. CPC H04W 76/19; H04L 43/0811; H04W 76/20

(57) ABSTRACT

Devices and methods where a repeater device determines that a failure event has occurred, and in response to this determining, stops performing a forwarding operation. The failure event may be with respect to a control link between a network-controlled repeater and a base station, such as a radio link failure or failure to comply with a configuration.

### TECHNICAL FIELD

Disclosed are embodiments related to nodes that perform repeater operations, and in particular, network controlled repeaters and the operation of such devices.

### BACKGROUND

Radio Link Monitoring (RLM) is a procedure performed by UEs in 3GPP systems. The purpose of the procedure is to monitor the radio link to the network. If, based on this monitoring, the UE experiences a problem with the link, the UE will declare Radio Link Failure (RLF). When the UE has declared RLF, the UE will typically attempt to connect to the network again. Depending on if security is enabled on the link to the network or not, the UE will apply different approaches, one being that the UE tries to reestablish the connection that just failed (called RRC reestablishment), another one being that the UE enters IDLE mode and attempts to establish a new connection. A difference in these approaches is that the UE's context (e.g., the UE's configuration) will be kept when the UE performs reestablishment, but that is not the case if the UE goes to IDLE mode and attempts to establish a new connection.

The Radio Resource Control (RRC) protocol can be used by a network to configure UEs. One way in which this is done is with a gNB sending RRC configuration/reconfiguration messages to the UE. The RRC entity in the UE applies the configurations within those messages. The UE will, when it applies such a configuration message, determine if the UE is unable to comply with the message. If the UE is unable to comply with (at least part of) the message, the UE will declare a failure. This failure is referred to as a reconfiguration failure and for New Radio (NR) is specified in 3GPP TS 38.331 v17.0.0, section 5.3.5.8.

Repeaters are one type of device that can be used to improve the coverage of a network. In some implementations, a repeater will listen to an incoming signal, and then re-send the same signal but amplified, hence improving the coverage.

There remains a need for improved network nodes, such as repeaters, performing forwarding operations, and control methods for such devices.

### SUMMARY

Certain challenges exist. For example, if the control link between a controlling base station (e.g., gNB) and another network node (e.g., a network-controlled repeater) is disrupted, the gNB is no longer in control of the repeater, and that repeater may provide unwanted emissions. Unwanted emissions may disturb other entities in the network, which may degrade user throughput and system capacity. Moreover, additional signaling may be required for reestablishing one or more of network control or forwarding operations, which can be inefficient.

In some embodiments, one or more of these challenges is addressed.

According to embodiments, a method is provided that comprises determining that a failure event has occurred with respect to a control link between the first network node and a second network node; and based at least in part on the determining, ceasing one or more forwarding operations and/or starting one or more failure event timers. In some embodiments, the first network node is a repeater device, such as a network-controlled repeater, and the second network node is a base station, such as a gNB. The method may further comprise resuming at least one forwarding operation. The forwarding operations may resume, for instance, once a control link has been re-established.

According to embodiments, a method is provided that comprises establishing a control link between a first network node and a second network node; and sending a failure event configuration from the second network node to the first network node. According to embodiments, the configuration comprises one or more configurations for ceasing forwarding operations or starting a timer upon detection of a failure event by the first network node. The configuration may also provide for resuming one or more forwarding operations, for example, following re-establishment. In some embodiments, the first network node is a repeater device, such as a network-controlled repeater, and the second network node is a base station, such as a gNB.

According to embodiments, a device, such as a repeater device or other network node, is provided that is configured to perform one or more of the methods. For example, an apparatus may comprise a receiver/transmitter and a processor, wherein the processor is configured to perform one or more of the methods. In some embodiments, such as network-controlled repeater embodiments, the apparatus may include a plurality of modules (e.g., a forwarding part and a mobile termination part). In certain aspects, a mobile termination part is able to communicate with a forwarding part via an internal interface.

According to embodiments, a computer program is provided that comprises instructions that when executed by processing circuitry of an apparatus causes the apparatus to perform one or more of the methods. The program can be contained on a carrier, where the carrier is one of an electronic signal, an optical signal, a radio signal, and a computer readable storage medium.

### BRIEF DESCRIPTION OF THE DRAWINGS

The accompanying drawings, which are incorporated herein and form part of the specification, illustrate various embodiments.

FIG. 1 illustrates a system according to embodiments.

FIG. 2 is a flow chart illustrating a process according to embodiments.

FIGS. 3A and 3B are flow charts illustrating processes according to embodiments.

FIG. 4 is a flow chart illustrating a process according to embodiments.

FIG. 5 is a schematic block diagram of a network node according to some embodiments.

FIG. 6 is a schematic block diagram of a user device according to some embodiments.

FIG. 7 is a schematic block diagram of a repeater device and system according to some embodiments.

### DETAILED DESCRIPTION

Aspects of the disclosure relate to radio link failure (RLF) with respect to repeater devices, repeater devices that are unable to comply with Radio Resource Control (RRC) configurations, and/or functionality of a repeater device at failure. One type of repeater is a network controlled repeater (NCR), which allows the network to control the operation of the repeater.

In certain aspects, embodiments disclose methods and devices that can provide efficient forwarding from nodes. Unwanted emissions can be avoided where a network node, such as a network-controlled repeater, is able to operate without direct control from the network. According to embodiments, this can improve system capacity, user throughput, and power consumption (e.g., where a repeater is battery powered). Also, reduced signaling overhead can be enabled through embodiments, for instance, signaling overhead between the repeater device and network can be reduced through pre-configuration.

According to embodiments, a repeater node will determine that a mobile termination part of the repeater has declared RLF or was unable to comply with a configuration message provided by the network. In response to this determining, the device stops performing a forwarding operation. For instance, an example scenario is described in which a repeater has a connection with a network node that allows the network node to control the repeater. In this example, the repeater experiences a failure and thereby loses (at least temporarily) the control connection to the network. In response, and according to embodiments, the repeater will stop its forwarding and/or start one or more failure event timers. This could comprise, for instance, powering down the amplification in the forwarding of the repeater. Failures due to an RLF event or a reconfiguration failure event are used as examples; however, other failure events may be used in embodiments.

According to an embodiment, a repeater device determines that a first event has occurred, and in response to this event, the device stops performing a forwarding operation. The first event may be a failure event that renders the connection to a network node controlling the device unusable. One example of such a failure event is an RLF event. Another example of such a failure event is that the device is unable to comply with (at least part) of a configuration that the network provides. This may be, for instance, a reconfiguration failure. Another example of such a failure event is that the device failed to select a suitable beam for performing transmissions and reception with the network, such as re-transmissions once a previously used beam failed. These failures may occur, for example, with respect to a mobile termination (MT) module of the device, including in an NCR-MT.

In certain aspects, the device stops the forwarding operation at a time T1 after the device experiences the failure event. A timer (e.g., having a value T1) may start immediately with the detection of the failure event, or with a predetermined delay according to embodiments. If the failure event is resolved within the time T1, the device, for instance its NCR-MT, will not stop forwarding operations. For example, if an NCR-MT experiences RLF and the radio link is reestablished before the time T1, the NRC will not stop forwarding. According to embodiments, the value of T1 may be configured for the repeater by the network, for instance, in an RRC message or via system information (SIB). Another approach is that the value of T1 is provided/configured by Operations, Administration and Maintenance (OAM) or specified in a specification. This approach, in which a delay T1 is used before forwarding operations are stopped, can have the benefit that if the repeater experiences a short interruption on the link that the network uses to control the repeater, the forwarding functionality can be maintained. This may beneficial, for example, if the link over which the repeater is controlled is obstructed while other signals (e.g., those that the repeater forwards) are unaffected. Different timing approaches may be implemented, either in addition to or instead of, the other timing approaches described herein.

In one embodiment, the device immediately starts a timer T2 when the failure is experienced and stops the forwarding operation right away. If the connection is restored before the timer T2 expires, then the repeater restarts the forwarding operation, otherwise it performs a recovery procedure. One example of a recovery procedure is RRC reestablishment.

In one embodiment, the device immediately starts a timer T3 when a first failure is experienced. In this example, the repeater does not stop the forwarding operations right away, but rather, it counts the number of failures that occur during the time period of the timer T3. In some embodiments, if the repeater reaches a number K of failures (e.g., a predetermined maximum number of failures) during the duration of the timer T3, then the repeater stops the forwarding operations and perform a recovery procedure. However, if the maximum number K or failures is not reached during the duration of the timer T3, then the repeater does not stop the forwarding operations. Accordingly, and in some embodiments, forwarding operations (or a subset of forwarding operations) may not be stopped in the event of a failure.

Aspects of one or more embodiments may be performed by a first entity within the device, for instance a mobile termination part (NCR-MT), such as determining that the RLF event has occurred. In certain aspects, this module instructs or otherwise causes a second entity, such as a forwarding part or NCR-FWD, within the device stop performing one or more forwarding operations. This could be achieved by the first entity sending an indication to the second entity. The indication may be sent either directly or indirectly (via a third entity). In some embodiments, the second entity (e.g., NCR-FWD) is configured by the first entity (e.g., NCR-MT).

In some embodiments, the device (e.g., in the first entity) determines that the RLF or other failure event applies to a first set of frequencies and stops performing the forwarding operation on that set of frequencies. For example, an RLF may be declared regarding the frequency(s) of the control link of the repeater, and the NCR stops forwarding on these frequency(s) if used on the access/backhaul links. In another version of this embodiment, the NCR stops performing the forwarding operation on a second set of frequencies. The first and second set of frequencies may be partially overlapping or non-overlapping. For example, this could occur where the NCR-MT determines that an RLF event occurred on frequency(s) F1 and the NCR stops performing forwarding on F1 and frequency(s) F2, with F2 partially or non-overlapping F1.

In some embodiments, the response of the repeater node, such as an NCR, can be preconfigured by the network. The configuration may be, for example, via a base station or other node of the network.

In one example, the network indicates whether the NCR shall stop the forwarding operation upon the first event or not, and/or after a selected timer period. This may, for example, be indicated in a dedicated RRC message or in system information (SIB). The NCR may consider one behavior as a default behavior, e.g., to stop the forwarding operation, and in absence of any indication of the opposite, the NCR would stop to forward upon the first event. This gives the network the freedom to control whether the NRC shall stop forwarding or not. Other indications can be sent, including indications or configurations to enable/instruct the repeater operations described herein, and/or timer values.

In certain aspects, there can be several reasons why the NCR-MT would declare RLF. For example, the NCR-MT may declare RLF if a measurement of a downlink (DL) signal is worse than a threshold (e.g., after some filtering), or if the NRC-MT performs a certain number of RLC retransmissions without getting an acknowledgement that the transmission was received by the network, which is sometimes referred to as RLC failure. Another example may be if a random-access (RA) procedure towards the network was not successful, which is sometimes referred to as RA failure. The DL signal RLF trigger event can happen in response to the fact that the DL signal is poor, while for example, an RLC retransmission failure event may be indicative that an uplink (UL) signal is of poor quality. In one embodiment, the NRC-MT will determine the reason for the failure-and depending on the reason-the NCR-MT will decide whether to stop forwarding or not. For example, the NCR may stop forwarding if the failure was due to the fact that a DL signal was poor, but not if the failure was due that RLC retransmissions failed. In yet another version of embodiments, the NCR will stop forwarding in DL (but not UL) in response to determining that RLF occurred due to DL signal problems, and the NCR will stop forwarding in UL in response to determining that RLF occurred due to problems in UL transmissions (e.g., RLC failure).

In some embodiments, the repeater device will resume forwarding. For example, and in one embodiment, an NCR resumes one or more forwarding operations in response to a second event. The second event may be that a connection to the network has been regained (e.g., the connection has been re-established), for instance. The second even could also be an explicit indication from the network to resume the forwarding operations. In some embodiments, the NCR only resumes forwarding if the NCR-MT reestablishes the connection within a certain cell or set of cells. If the NCR-MT reestablishes the connection to another cell (or cells), the NCR will not resume the forwarding operation. The certain set of cells may be limited to the cell to which the NCR-MT was connected to prior to the first failure event, or a cell in the same area as the cell the NCR-MT was connected to prior to the first failure event (e.g., same tracking area, registration area, RAN area, etc.). In another example, the acceptable cells may share the same beam management configuration (e.g., Transmission Configuration Information (TCI) state) as the cell that the NCR-MT was connected to prior to the first failure event.

In some embodiments, whether the NCR (or other repeater device) shall resume one or more forwarding operations may be indicated by the network. This may be, for example, indicated to the NCR-MT during the time that the NCR-MT reestablishes the connection to the network. In some embodiments, it is an indication sent from the network to the NCR-MT in a reestablishment message.

In some embodiments, the NCR (or other repeater device) resumes forwarding operation on all frequencies that the NCR was forwarding before it stopped forwarding. In other embodiments, the NCR resumes forwarding only on a subset of the frequencies that the NCR stopped forwarding. In another version of this embodiment, the NCR resumes forwarding on a set of frequencies indicated by the network, for example, indicated by the network in the procedure when the connection is re-established. In other embodiments, when a failure is detected, the NCR may attempt to reconnect to the network node on a different frequency (previously configured), possibly prior to a time-out. Here, the NCR may choose any of the carriers that are configured. The choice may further be based on past measurements, for instance, to determine appropriate TCI states for the carriers within the first or second sets of frequencies, such that a carrier with a better signal strength at the repeater is preferred to a carrier with a worse signal strength. In certain aspects, the network configures at the NCR-MT different carriers (e.g., cells) that can be used as a fallback by the NCR-MT when a failure is experienced. In this case, the network knows that a failure has been experienced by the NCR-MT and that a new carrier (cell) is used by the NCR when receiving the first uplink message by the NCR-MT.

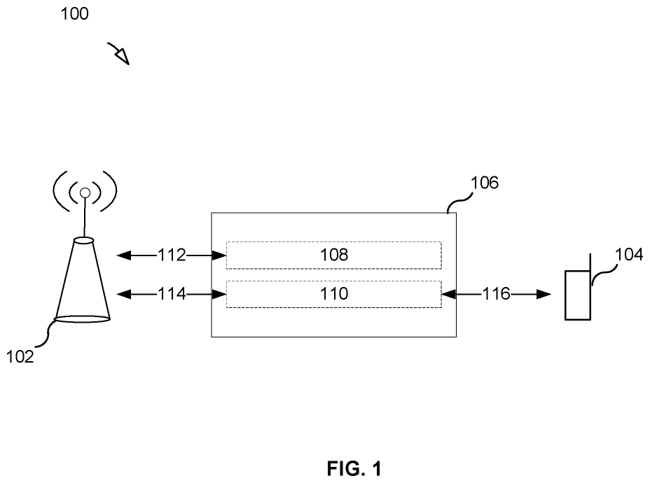

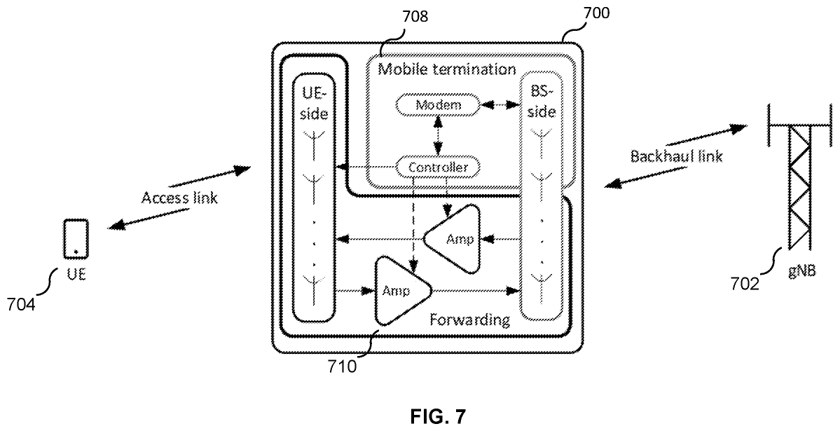

Referring to FIG. 1, a communication system 100 is shown according to some embodiments. In certain aspects, FIG. 1 depicts a schematic example of how a network node with forwarding capabilities, such as a network controlled repeater or other repeater device, could communicate with a network (e.g., via a base station). The system may, for instance, implement 5G new radio (NR) or other protocols and include a network node 102, a UE 104, and another network node 106 configured for forwarding operations. The node 102 may be, for instance, a base station, such as one or more NBs, eNBs, gNBs or other types of wireless access points or network nodes. The UE 104 may be any form of UE according to embodiments, such as mobile telephones, personal digital assistants, electronic readers, portable electronic tablets, wireless sensors, machine communication devices, personal computers, and laptop computers. The other network node 106 may be a repeater device, such as a network-controlled repeater (NCR), an RF repeater, or other node configured to perform forwarding operations. In certain aspects, an NCR can provide enhancements over an RF repeater by including functionality to receive and process information from the network. Examples of aspects of an NCR according to some embodiments are further described with respect to FIG. 7.

In some embodiments, the node 106 is an NCR comprising two main parts 108, 110. A first part is a forwarding part (NCR-FWD) 110 that handles forwarding operations, such as taking the signal from the gNB 102 on a first link 114 (e.g., a backhaul link) and forwarding an amplified version of it that can then be received by the UE 104 on a second link 116 (e.g., an access link). The repeater node 106 can also receive signals from the UE 104 on the access link 116 and forward an amplified version for reception by the gNB 102 on the backhaul link 114. According to some embodiments, the other main part is the mobile termination part (NCR-MT) 108. In certain aspects, this part can enable network control on a control link 112 and allow the gNB 102 to communicate with the repeater node 106. In some embodiments, an NCR-MT 108 terminates the control link 112 as a UE would.

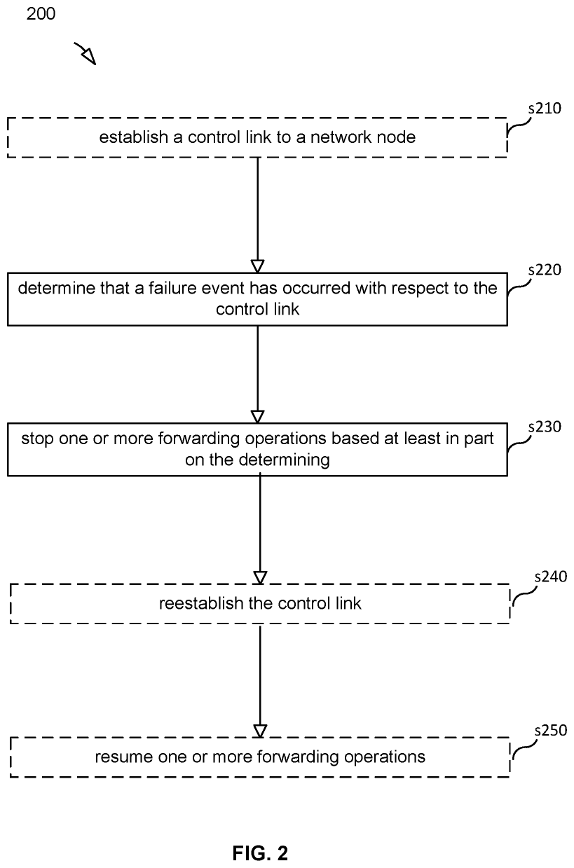

Referring now to FIG. 2, a process 200 is provided according to some embodiments. The process 200 may be performed, for instance, by a network node 106 as described in connection with FIGS. 1, 5, and 7.

The process 200 may begin, in some embodiments, with step s210 in which a control link is established between first and second network nodes, such as between a gNB and a network-controlled repeater. In step s220, the first network node determines that a failure event has occurred with respect to the control link. Examples of failure events can include RLF or an inability to comply with a configuration message provided by the network. In step s230, in response to the determining, the first network node stops one or more forwarding operations. In steps s240, which may be optional in some embodiments, the control link can be reestablished. In step s250, which may be optional in some embodiments, one or more of the forwarding operations are resumed.

According to embodiments, one or more of stopping (s230), reestablishing (s240), and resuming (s250) can be based, at least in part, on the use of a timer.

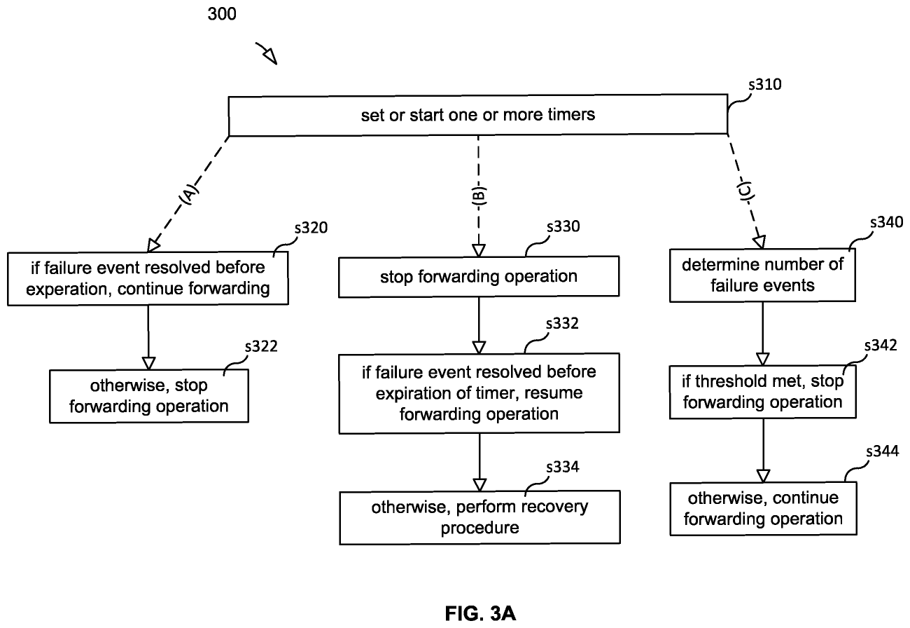

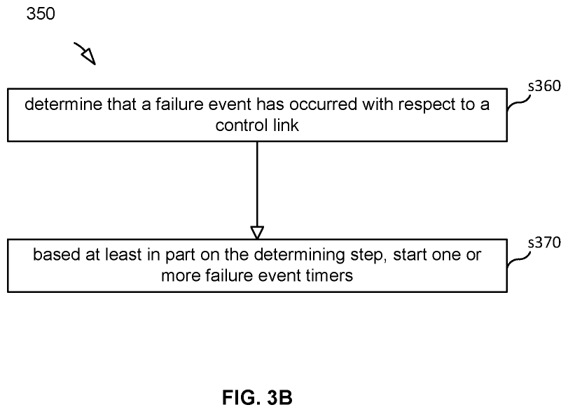

Referring now to FIG. 3A, process 300 for use of a timer is described according to embodiments. The process 300 may be part of, for example, process 200 or 350 in some embodiments. For instance, the process 300 may be a part of step s370 and process 350, or one more of steps s220, s230, s240, or s250 of process 200. The process 300 may begin with step s310, in which one or more timers are set or started. In certain aspects, the timer is started with the detection of a failure event. However, starting of the timer may be delayed a predetermined period in some embodiments.

In a first embodiment (A), if a failure event is resolved before the timer expires, forwarding operations may continue s320. Otherwise, in step s322, one or more forwarding operations are stopped. According to some embodiments, a network node (e.g., a network-controlled repeater 106), determines whether a failure event has been resolved, and based on whether a timer has expired or not (or a time threshold has otherwise been met), the forwarding operations are selectively stopped or continued. In a second embodiment (B), the forwarding operation is stopped at step s330. Then, in step s332, if the failure event is resolved before expiration of the timer, the node will resume forwarding operations. Otherwise, in step s334, the node performs a recovery procedure. In a third embodiment (C), the node determines a number of failure events in step s340. If the number of threshold events meets or exceeds a threshold, the node will stop one or more forwarding operations in step s342. However, if the threshold is not met, the forwarding operation is continued in step s344. In some embodiments, stopping forwarding operations is conditional based on one or more of a timer and/or a determination of the number of failure events. In some embodiments, however, the threshold counting process may be implemented without the use of timer or step s310. That is, a node may count a number of events and selectively stop forwarding if a threshold is met. This may be a running count, or may be a determination that a number of events occurred in a given time window.

Referring now to FIG. 3B, a process 350 is provided according to some embodiments. As with process 300, the process 350 may be performed, for instance, by a network node 106, such as a network-controlled repeater or any other repeater device described with respect to FIGS. 1, 5, and 7. In step s360, the node determines that a failure event has occurred with respect to a control link. In step s370, based at least in part on the determining, the node can start one or more failure event timers. According to embodiments, one or more steps of processes 200 and 300 may follow step s370, including selectively stopping forwarding operations or not.

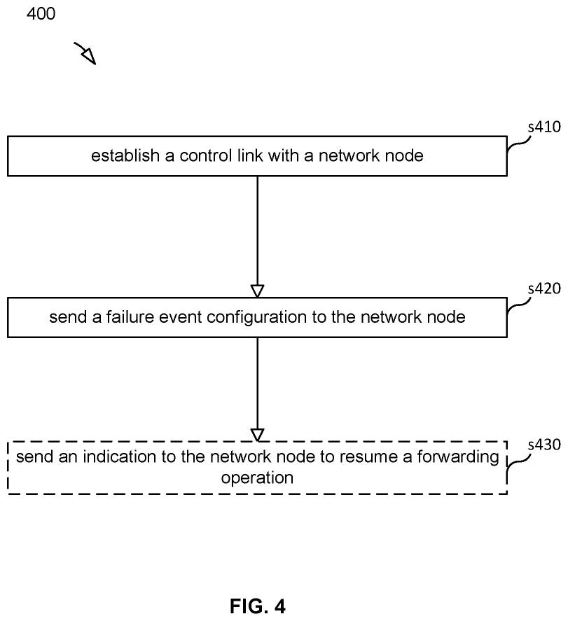

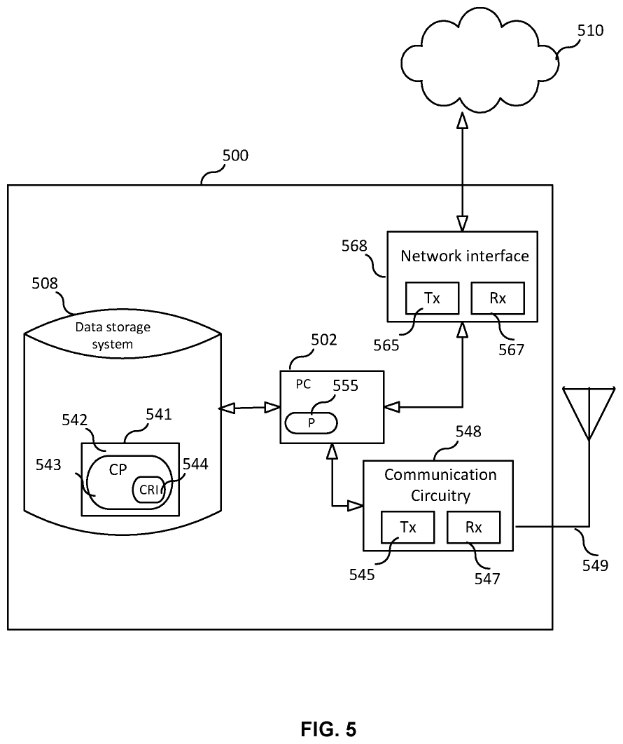

Referring now to FIG. 4, a process 400 is provided according to some embodiments. The process 400 may be performed, for instance, by a network node 102 as described in connection with FIGS. 1 and 5. The process may begin, for example, with step s410 where a control link is established with another node, such as a network-controlled repeater 106 or other repeater device. In step s420, a failure event configuration is sent to the other node (e.g., a node configured as a repeater). According to embodiments, the configuration causes the repeater to perform one or more steps of processes 200, 300, and/or 350. In step s430, which may be optional in some embodiments, an indication is sent to the repeater device to resume a forwarding operation. This may be, for example, a forwarding operation that was previously stopped in accordance with the configuration sent in step s420.

Referring now to FIG. 5, a block diagram of an apparatus 500 is shown according to some embodiments. The apparatus 500 may be, for example, a network node such as node 102, 106, 700, or 702. As shown in FIG. 5, apparatus 500 may comprise: processing circuitry (PC) 502, which may include one or more processors (P) 555 (e.g., one or more general purpose microprocessors and/or one or more other processors, such as an application specific integrated circuit (ASIC), field-programmable gate arrays (FPGAs), and the like), which processors may be co-located in a single housing or in a single data center or may be geographically distributed (i.e., apparatus 500 may be a distributed computing apparatus); a network interface 568 comprising a transmitter (Tx) 565 and a receiver (Rx) 567 for enabling apparatus 500 to transmit data to and receive data from other nodes connected to a network 510 (e.g., an Internet Protocol (IP) network) to which network interface 568 is connected; communication circuitry 548, which is coupled to an antenna arrangement 549 comprising one or more antennas and which comprises a transmitter (Tx) 545 and a receiver (Rx) 547 for enabling apparatus 500 to transmit data and receive data (e.g., wirelessly transmit/receive data); and a local storage unit (a.k.a., “data storage system”) 508, which may include one or more non-volatile storage devices and/or one or more volatile storage devices. In embodiments where PC 502 includes a programmable processor, a computer program product (CPP) 541 may be provided. CPP 541 includes a computer readable medium (CRM) 542 storing a computer program (CP) 543 comprising computer readable instructions (CRI) 544. CRM 542 may be a non-transitory computer readable medium, such as, magnetic media (e.g., a hard disk), optical media, memory devices (e.g., random access memory, flash memory), and the like. In some embodiments, the CRI 544 of computer program 543 is configured such that when executed by PC 502, the CRI causes apparatus 500 to perform steps described herein (e.g., steps described herein with reference to the flow charts). In other embodiments, apparatus 500 may be configured to perform steps described herein without the need for code. That is, for example, PC 502 may consist merely of one or more ASICs. Hence, the features of the embodiments described herein may be implemented in hardware and/or software.

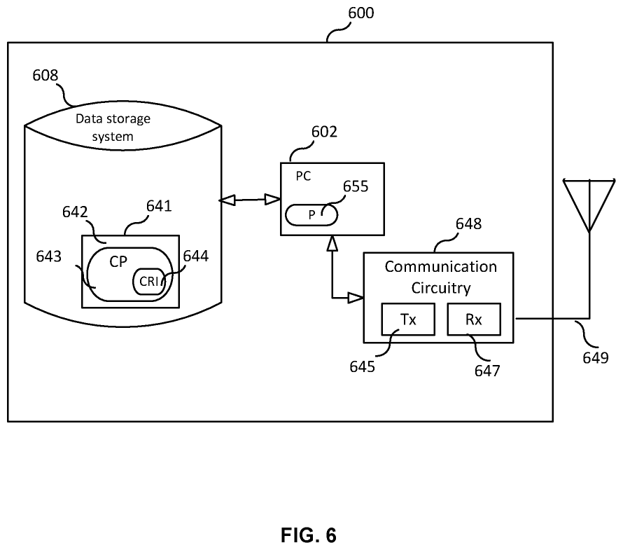

Referring now to FIG. 6, FIG. 6 is a block diagram of a user device (e.g., a UE such as UE 104 or 704), according to some embodiments. As shown in FIG. 6, the device may comprise: processing circuitry (PC) 602, which may include one or more processors (P) 655 (e.g., one or more general purpose microprocessors and/or one or more other processors, such as an application specific integrated circuit (ASIC), field-programmable gate arrays (FPGAs), and the like); communication circuitry 648, which is coupled to an antenna arrangement 649 comprising one or more antennas and which comprises a transmitter (Tx) 645 and a receiver (Rx) 647 for enabling the device to transmit data and receive data (e.g., wirelessly transmit/receive data); and a local storage unit (a.k.a., “data storage system”) 608, which may include one or more non-volatile storage devices and/or one or more volatile storage devices. In embodiments where PC 602 includes a programmable processor, a computer program product (CPP) 641 may be provided. CPP 641 includes a computer readable medium (CRM) 642 storing a computer program (CP) 643 comprising computer readable instructions (CRI) 644. CRM 642 may be a non-transitory computer readable medium, such as, magnetic media (e.g., a hard disk), optical media, memory devices (e.g., random access memory, flash memory), and the like. In some embodiments, the CRI 644 of computer program 643 is configured such that when executed by PC 602, the CRI causes the device to perform steps described herein (e.g., steps described herein with reference to the flow charts). In other embodiments, the device may be configured to perform steps described herein without the need for code. That is, for example, PC 602 may consist merely of one or more ASICs. Hence, the features of the embodiments described herein may be implemented in hardware and/or software.

Referring now to FIG. 7, a network-controller repeater 700 is illustrated according to some embodiments. In certain aspects, FIG. 7 shows a schematic of exemplary building blocks of a network-controlled repeater, and how it could communicate with the network and/or a UE. According to some embodiments, node 106 can be configured as shown in FIG. 7. While an NCR is used as an example, other repeater devices may be used according to embodiments and configured as shown in FIG. 7.

In this example, the NCR 700 comprises three principal building blocks: the modem, the controller module, and the repeater or forwarding module (depicted in this example as having two amplifiers). This may include, for example, a mobile termination or NCR-MT 708 and a forwarding part or NCR-FWD 710. In this example, the NCR 700 is equipped with an antenna configuration, where a signal is first received in downlink from the gNB 702 (or uplink from the UE 704), and, for example after power amplification, transmitted further in downlink (or uplink). Since the repeater module of this example only amplifies and (analogously) beamforms the signal, no advanced receiver or transmitter chains may be required, which can reduce the cost and energy consumption compared to certain Transmission and Reception Points (TRPs). According to embodiments, the NCR-FWD 110 part in FIG. 1 may use this configuration. In certain aspects, different antenna modules are used for the donor and service sides, i.e., the antennas targeting the gNB 702 and UE 704, respectively. In some embodiments, for instance using a more complex architecture including self-interference cancellation, using the same antenna modules for both sides is an option.

Further referring to the example of FIG. 7, a modem module may be used that is able to exchange control and status signaling with a gNB 702 controlling the NCR. For this, the modem module can supports at least a sub-set of UE functions. In some embodiments, NCR control and status information is further exchanged between the modem module and the controller module. In certain aspects, the modem module might be equipped with antennae separated from the antennae used by the repeater module; however, in some configurations, the modem module and repeater module share antenna configurations. In some embodiments, the controller module is used to control the repeater module, for example, by providing beamforming information, power control information, etc. In certain aspects, the controller module is connected to the network through the modem module such that the network can control the controller module and, in that way, control the repeater module.

In some embodiments, the repeater module's amplify-and-forward operation is controlled by the control module. The control module could also be directly responsible for the beamforming control on the service antenna side, i.e., to/from a served UE 704. In an alternative, the beamforming on the service antenna side is operated by the repeater module under control of the control module. On the donor antenna side, i.e., to/from the controlling gNB 702, the modem module could be directly responsible for the beamforming control. In an alternative, the beamforming on the service antenna side is operated by the repeater module under control of the control module and/or modem module. In one configuration, the modem module and the repeater module do not only share an antenna configuration but also parts of the transmitter and/or receiver, such as power (transmit) amplifier and/or receiver amplifiers and/or filters.

According to some embodiments, the modem module and the repeater module can operate at the same or different frequencies. For example, the repeater module could operate at a higher frequency band (FR2) and the modem module could operate at a lower frequency band (FR1).

According to some embodiments, one or more of, or both of, the modem and controller module are part of the Mobile Termination (MT) function in the NCR. For example, NCR-MT 108 shown in FIG. 1 can implement the modem and/or control modules shown in FIG. 7.

### Summary of Embodiments

A1. A method in a first network node, comprising: determining that a failure event has occurred with respect to a control link between the first network node and a second network node; and based at least in part on the determining, stopping one or more forwarding operations.
A2. The method of A1, wherein the first network node is a network-controlled repeater.
A3. The method of A1 or A2, further comprising: resuming at least one forwarding operation.
A4. The method of any of A1-A3, wherein the first network node is configured to perform one or more of: forwarding signals to the second network node on a first link (e.g., on an uplink of the backhaul link); and forwarding signals to a user equipment, UE, on a second link (e.g., a downlink of the access link).
A5. The method of any of A1-A4, wherein one or more of stopping or resuming forwarding operations is performed by the first network node without receiving a stop or resume command from the second network node.
A6. The method of any of A1-A5, further comprising: establishing the control link between the first and second network nodes (e.g., via a random access procedure, such as a 2-step or 4-step random-access channel, RACH, process).
A7. The method of any of A1-A6, wherein the failure event is a radio link failure, RLF.
A8. The method of A7, wherein determining that a failure event (e.g., RLF) has occurred is based at least in part on: (i) a measurement of control link uplink or downlink signal (e.g., determining that a signal strength does not meet a threshold); (ii) a number of Radio Link Control, RLC, retransmissions without receiving an acknowledgment; or (iii) a failed random-access procedure with the second network node.
A9. The method of any of A1-A8, wherein the failure event comprises a reconfiguration failure.
A10. The method of any of A1-A6, wherein the failure event is a failure to re-select a beam for transmission or reception following a beam failure.
A11. The method of any of A1-A10, wherein determining that a failure event has occurred comprises determining that the first network node is unable to comply with a configuration (e.g., a configuration previously received from the network).
A12. The method of any of A1-A11, further comprising: receiving a failure event configuration (e.g., from the second network node via a Radio Resource Control, RRC, message or via system information block, SIB), wherein one or more of the determining and stopping a forwarding operation is based at least in part on the received configuration.
A13. The method of A12, wherein the failure event configuration comprises one or more of: (i) a failure event timer configuration (e.g., one or more timer values and/or use cases); (ii) a signal strength threshold for a failure event; (iii) a threshold number of RLC retransmissions or preamble transmissions for a failure event; and (iv) an indication for the first network node to stop forwarding upon a first detected failure event.
A14. The method of any of A1-A13, wherein stopping one or more forwarding operations comprises at least one of reducing signal amplification levels, or stopping signal transmission and/or reception on one or more sets of frequencies.
A15. The method of any of A1-A14, wherein the failure event corresponds to a first set of frequencies, wherein the stopping one or more forwarding operations comprises at least one of: (i) stopping forwarding on the first set of frequencies; (ii) stopping forwarding on a second set of frequencies; (iii) stopping forwarding on the first set of frequencies but not the second set of frequencies; or (iv) stopping forwarding on the first set of frequencies and the second set of frequencies.
A16. The method of any of A3-A15, wherein resuming one or more forwarding operations comprises at least one of: (i) resuming the forwarding operation in response to detection of a second event (e.g., based on a determination that the control link has been reestablished or based on an indication from the second network node to resume the forwarding operation); (ii) resuming the forwarding operations upon reconnection with a same cell (or cells) that the first network node was connected to prior to the failure event; (iii) resuming the forwarding operations upon reconnection with a cell (or cells) in the same area (e.g., same tracking area, registration area, or Radio Access Network, RAN, area) as the cell that the first network node was connected to prior to the failure event; (iv) resuming the forwarding operations upon reconnection with a cell having the same beam management configuration as the cell that the first network node was connected to prior to the failure event; (v) receiving an indication from the network (e.g., second network node) to resume the forwarding operation (e.g., in a reestablishment message and/or a message indicating a set of frequencies for resumed forwarding); (vi) resuming the forwarding operation on all frequencies that were used prior to the failure event; or (vii) resuming the forwarding operation on less than all of the frequencies that were used prior to the failure event.
A17. The method of any of A1-A16, wherein stopping one or more forwarding operations comprises: starting one or more timers when the failure event is determined.
A18. The method of any of A1-A17, wherein stopping one or more forwarding operations comprises: starting a first timer T1, wherein at least one forwarding operation is stopped when the first timer expires.
A19. The method of any of A1-A18, wherein stopping one or more forwarding operations comprises starting a second timer T2, wherein at least one forwarding operation is stopped when the second timer is started, further comprising: restoring the control link to the second network node before expiration of the second timer; and resuming one or more forwarding operations based at least in part on the restoring before expiration of the second timer.
A20. The method of any of A1-A18, wherein performing the stop forwarding operation comprises starting a second timer T2, wherein at least one forwarding operation is stopped when the second timer is started, further comprising: after expiration of the second timer without restoring the control link to the second network node, performing a recovery procedure (e.g., an RRC reestablishment).
A21. The method of A20, further comprising: attempting to restore the control link to the second network node.
A22. The method of any of A1-A21, wherein performing the stop forwarding operation comprises: staring a third timer T3, determining a number of failure events that occur; and based at least in part on the determining and wherein the number of failure events meets a threshold before expiration of the third timer, stopping one or more forwarding operations.
A23. The method of any of A17-A22, wherein the value of the timer is pre-configured in the first network node, or wherein the value of the timer is configured by a message received from the second network node.
A24. The method of any of A1-A23, wherein the determining is performed by a first module of the first network node (e.g., a mobile termination unit) and forwarding operations are performed by a second module of the first network node (e.g., a forwarding unit).
A25. The method of A24, further comprising: sending a failure event indication from the first module to the second module.
A26. The method of A24 or A25, wherein the second module is configured by the first module.
A27. The method of any of A1-A26, wherein one or more forwarding operation comprises beamforming a forwarded signal.
A28. The method of any of A1-A27, wherein the second network node is a base Station (e.g., gNB).
A29. The method of any of A1-A28, further comprising: reestablishing the control link between the first and second network nodes.
A30. The method of A29, wherein the control link is reestablished on a different frequency (or set of frequencies) than the initial control link.
A31. The method of A30, further comprising: selecting the different frequency, wherein the different frequency is selected based on a signal strength measurement between the first and second network nodes.
A32. The method of any of A29-A31, wherein the reestablishing comprises RRC reestablishment or entering idle mode and establishing a new connection to the second network node.
A33. The method of any of A1-A32, wherein the stopping one or more forwarding operations is based at least in part on a type of the failure event.
A34. The method of any of A1-A33, wherein the stopping one or more forwarding operations comprises: stopping forwarding on a downlink channel but not an uplink channel in response to determining that an RLF occurred with respect to the downlink channel; or stopping forwarding on an uplink channel but not a downlink channel in response to determining that an RLF occurred with respect to the uplink channel.
B1. A first network node (e.g., a repeater device) configured to: determine that a failure event has occurred with respect to a control link between the first network node and a second network node (e.g., a gNB); and based at least in part on the determining, stop one or more forwarding operations.
B2. The node of B1, further configured to perform any of the steps of A2-A34.
B3. The node of B1 or B2, comprising a first module and a second module, wherein the determining is performed by the first module (e.g., a mobile termination unit) and forwarding operations are performed by the second module (e.g., a forwarding unit).
B4. The node of any of B1-B3, comprising one or more of: a modem; a controller module; and/or a repeater module (e.g., wherein the controller module controls the repeater module).
B5. The node of B4, wherein the modem module is configured to exchange control and/or status signaling with the second network node, and wherein the modem is further configured to provide control and/or status information to the controller module.
B6. The node of B4 or B5, wherein the repeater module comprises a plurality of amplifiers configured to forward uplink and downlink signals received by the first network node.
B7. The node of any of B4-B6, where at least one of the modem, controller module, and repeater module is configured to perform beamforming of forwarded signals.
B8. The node of any of B4-B7, wherein the modem and/or controller module operate on a first set of frequencies, and the repeater module operates on a second, different set of frequencies.
B9. The node of any of B1-B8, comprising one or more shared components (e.g., antennas, amplifiers, receivers, and/or filters).
B10. The node of any of B1-B9, wherein the first network node is a network-controlled repeater.
C1. A method, comprising: establishing a control link between a first network node and a second network node; and sending a failure event configuration from the second network node to the first network node, wherein the configuration comprises one or more configurations for stopping forwarding operations upon detection of a failure event by the first network node.
C2. The method of C1, wherein the first network node is a network-controlled repeater and the second network node is a base station (e.g., gNB).
C3. The method of C1 or C2, wherein the failure event configuration comprises one or more of: (i) a failure event timer configuration (e.g., one or more timer values and/or use cases); (ii) a signal strength threshold for a failure event; (iii) a threshold number of Radio Link Control, RLC, retransmissions or preamble transmissions for a failure event; or (iv) an indication for the first network node to stop forwarding upon a first detected failure event.
C4. The method of any of C1-C3, further comprising: sending an indication to the first network node to resume a forwarding operation (e.g., in a reestablishment message and/or a message indicating a set of frequencies for resumed forwarding).
C5. The method of any of C1-C4, wherein the configuration causes the first network node to perform any of the steps of A1-A34 or E1-E5.
D1. A network node configured to: establish a control link between the node and a repeater device (e.g., a network-controlled repeater); and send a failure event configuration to the repeater device, wherein the configuration comprises one or more configurations for stopping forwarding operations upon detection of a failure event by the repeater device.
D2. The network node of D1, further configured to perform any of C2-C5.
D3. The network node of D1 or D2, wherein the node is a base station (e.g., gNB).
E1. A method in a first network node, comprising: determining that a failure event has occurred with respect to a control link between the first network node and a second network node; and based at least in part on the determining, starting one or more failure event timers.
E2. The method of E1, further comprising: restoring the control link to the second network node before expiration of a first timer; and continuing one or more forwarding operations.
E3. The method of E1 or E2, further comprising: determining a number of failure events that occur; and wherein the number of failure events does not meet a threshold before expiration of a second timer, continuing one or more forwarding operations.
E4. The method of any of E1-E3, wherein the value of timer is pre-configured in the first network node, or wherein the value of the timer is configured by a message received from the second network node.
E5. The method of any of E1-E4, further comprising any of the steps of A1-A34.
F1. A first network node (e.g., a repeater device) configured to: determine that a failure event has occurred with respect to a control link between the first network node and a second network node (e.g., gNB); and based at least in part on the determining, starting one or more failure event timers.
F2. The node of F1, further configured to perform any of the steps of E2-E5 or A1-A34.
F3. The node of F1 or F2, further comprising any of B2-B10.
F4. The node of any of F1-F3, wherein the first network node is a network-controlled repeater.
G1. A computer program product comprising a non-transitory computer readable medium storing instructions which when performed by processing circuitry of a device causes the device to perform any of A1-A34, C1-C5, or E1-E5.

While various embodiments are described herein, it should be understood that they have been presented by way of example only, and not limitation. Thus, the breadth and scope of this disclosure should not be limited by any of the above described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method in a first network node, comprising:
determining that a failure event has occurred with respect to a control link between the first network node and a second network node;
based at least in part on the determining, ceasing one or more forwarding operations; and
resuming at least one forwarding operation.

2. The method of claim 1, wherein the first network node is a network-controlled repeater (NCR).

3. The method of claim 1, wherein the at least one forwarding operation is resumed after reestablishing the control link between the first and second network nodes.

4. The method of claim 3, wherein reestablishing the control link comprises performing Radio Resource Control (RRC) reestablishment.

5. The method of claim 1, further comprising:
detecting a second event,
wherein resuming the at least one forwarding operation is in response to the detection of the second event.

6. The method of claim 5,
wherein detecting the second event comprises a determination that the control link has been reestablished; or
wherein detecting the second event comprises receiving an indication from the second network node to resume the forwarding operation.

7. (canceled)

8. The method of claim 1, wherein the first network node is configured to perform one or more of:
forwarding signals to the second network node on an uplink of a backhaul link; or
forwarding signals to a user equipment (UE) on a downlink of an access link.

9. The method of claim 1, wherein one or more of ceasing or resuming forwarding operations is performed by the first network node without receiving a stop or resume command from the second network node.

10. The method of claim 1,
wherein the failure event is a radio link failure (RLF);
wherein the failure event is a beam failure;
wherein the failure event comprises a failure to re-select a beam for transmission or reception following a beam failure; or
wherein determining that a failure event has occurred comprises determining that the first network node is unable to comply with a configuration.

11. The method of claim 1, wherein determining that the failure event has occurred is based at least in part on:
(i) a measurement of control link uplink or downlink signal;
(ii) a number of Radio Link Control (RLC) retransmissions without receiving an acknowledgment; or
(iii) a failed random-access procedure with the second network node.

12. The method of claim 1, wherein the failure event comprises a reconfiguration failure.

13-15. (canceled)

16. The method of claim 1, wherein ceasing one or more forwarding operations comprises at least one of reducing signal amplification levels, or stopping signal transmission and/or reception on one or more sets of frequencies.

17. The method of claim 1, wherein ceasing one or more forwarding operations comprises:
starting one or more timers when the failure event is determined.

18. The method of claim 1, further comprising:
attempting to restore the control link to the second network node.

19-24. (canceled)

25. The method of claim 1, further comprising:
reestablishing the control link between the first and second network nodes.

26. The method of claim 25, wherein the control link is reestablished on a different frequency or different set of frequencies than the initial control link.

27. The method of claim 25, wherein the reestablishing comprises RRC reestablishment or entering idle mode and establishing a new connection to the second network node.

28. The method of claim 1, wherein the ceasing one or more forwarding operations is based at least in part on a type of the failure event.

29. The method of claim 1, wherein the ceasing one or more forwarding operations comprises:
stopping forwarding on a downlink channel but not an uplink channel in response to determining that an RLF occurred with respect to the downlink channel; or
stopping forwarding on an uplink channel but not a downlink channel in response to determining that an RLF occurred with respect to the uplink channel.

30. A first network node configured to:
determine that a failure event has occurred with respect to a control link between the first network node and a second network node;
based at least in part on the determining, cease one or more forwarding operations; and
resume at least one forwarding operation.

31-47. (canceled)
